(19) United States
(12) Patent Application Publication
(10) Pub. No.: US 2025/0337228 A1
(43) Pub. Date: Oct. 30, 2025

(54) HOLDER BODY AND VEHICLE BODY FIXING STRUCTURE

(71) Applicant: Yazaki Corporation, Tokyo (JP)

(72) Inventors: Tomohiro URASHIMA, Nasukarasuyama-shi (JP); Genki FURUYA, Nasukarasuyama-shi (JP); Hiroyasu FURUYA, Nasukarasuyama-shi (JP)

(73) Assignee: Yazaki Corporation, Tokyo (JP)

(21) Appl. No.: 19/083,974

(22) Filed: Mar. 19, 2025

(30) Foreign Application Priority Data
Apr. 24, 2024 (JP) 2024-070472

(51) Int. Cl. H02G 5/02; H01M 50/507; H01R 25/16

(52) U.S. Cl. CPC H02G 5/025; H01M 50/507; H01R 25/162

(57) ABSTRACT

A holder body is configured to support a bus bar having a straight portion in a strip shape, and to be fixed to a fixing target of a vehicle body, and includes a holder main body in the shape of a gutter capable of accommodating the straight portion, a cover material in a plate shape assembled onto the holder main body to hold the straight portion, and a pressing portion provided on a side away from the straight portion to press and support the cover material, wherein the pressing portion includes a pressing portion main body in a plate shape provided to be able to engage with the holder main body so as to face the cover material, and a contact rib provided to protrude from the pressing portion main body toward the cover material so as to be able to come into contact with the cover material.

### TECHNICAL FIELD

The present invention relates to a holder body and a vehicle body fixing structure.

### BACKGROUND

Conventionally, as a connection member used to connect battery modules mounted on a vehicle, bus bars have been widely installed in the form of protector-equipped bus bars, in which bus bars are housed in bus bar protectors made of insulating resin (see, for example, Patent Document 1).

The protector-equipped bus bar described in Patent Document 1 includes a bus bar and a bus bar protector that covers the periphery of the bus bar to insulate the bus bar, and is configured such that connection portions provided at the ends of the bus bar to be connected to connection targets are exposed. The bus bar protector includes a pair of protector pieces that position the bus bar between them, and a claw structure for connecting the pair of protector pieces together, and is configured to be fixed to a predetermined position on a vehicle body.

### RELATED ART

### Patent Document

Patent Document 1: JP2017-59436A

### SUMMARY OF THE INVENTION

### Problem to be Solved by the Invention

However, when a task such as maintenance is performed, the conventional protector-equipped bus bars described in Patent Document 1 are disconnected from the connection targets, and the fixing of the bus bar protectors to the vehicle body is released to temporarily remove the protector-equipped bus bars from the vehicle body, and then the protector-equipped bus bars are disassembled and the bus bars are removed from the bus bar protectors. Therefore, when the task such as maintenance is completed, the protector-equipped bus bars that are assembled by reattaching the bus bar protectors to the bus bars need to be fixed to a predetermined position on the vehicle body, which reduces the ease of maintenance.

It is an object of the present invention to provide a holder body and a vehicle body fixing structure that improve the ease of maintenance by allowing only the bus bar to be removed while the holder body and the vehicle body fixing structure remain fixed to the vehicle body.

### Solution to Problem

In order to solve the above problems and achieve the object, the first aspect is a holder body configured to support a bus bar having a straight portion in a strip shape, and to be fixed to a fixing target of a vehicle body, including a holder main body in a shape of a gutter capable of accommodating the straight portion, a cover material in a plate shape assembled onto the holder main body and configured to cover and hold the straight portion with the holder main body, and a pressing portion provided on a side away from the straight portion with respect to the cover material so as to press and support the cover material, wherein the cover material is provided to be capable of being accommodated in the holder main body so as to cover the straight portion, wherein the pressing portion includes a pressing portion main body in a plate shape provided to be able to engage with the holder main body so as to face the cover material, and a contact rib provided to protrude from the pressing portion main body toward the cover material so as to be able to come into contact with the cover material.

The second invention is a vehicle body fixing structure including a pair of bus bar support bodies each including the holder body according to claim 1 and the bus bar, wherein the bus bar is configured such that an outer surface of the straight portion is covered with an insulating coating portion having an insulating property, the holder body of each of the pair of bus bar support bodies includes a fixed portion configured to be fixed to the fixing target, and the pair of bus bar support bodies are fixed such that each of the fixed portion is fixed to the corresponding fixing target while the holder main bodies are arranged back-to-back.

### Advantageous Effects of the Invention

According to the present invention, the ease of maintenance can be improved by allowing only the bus bar to be removed while the bus bar main body remains fixed to the vehicle body.

### BRIEF DESCRIPTION OF THE DRAWINGS

FIG. 1 is a perspective view illustrating a vehicle body fixing structure according to an embodiment of the present invention that is fixed to a vehicle body.

FIG. 2 is a perspective view illustrating a holder body that constitutes the vehicle body fixing structure.

FIG. 3 is an exploded perspective view illustrating the disassembled holder body.

FIG. 4 is a cross-sectional view taken along line I-I of FIG. 2.

FIG. 5 is a perspective view of the holder body from a different angle.

FIG. 6 is a perspective view for explaining how the vehicle body fixing structure is assembled.

### DETAILED DESCRIPTION OF THE EXEMPLARY EMBODIMENT

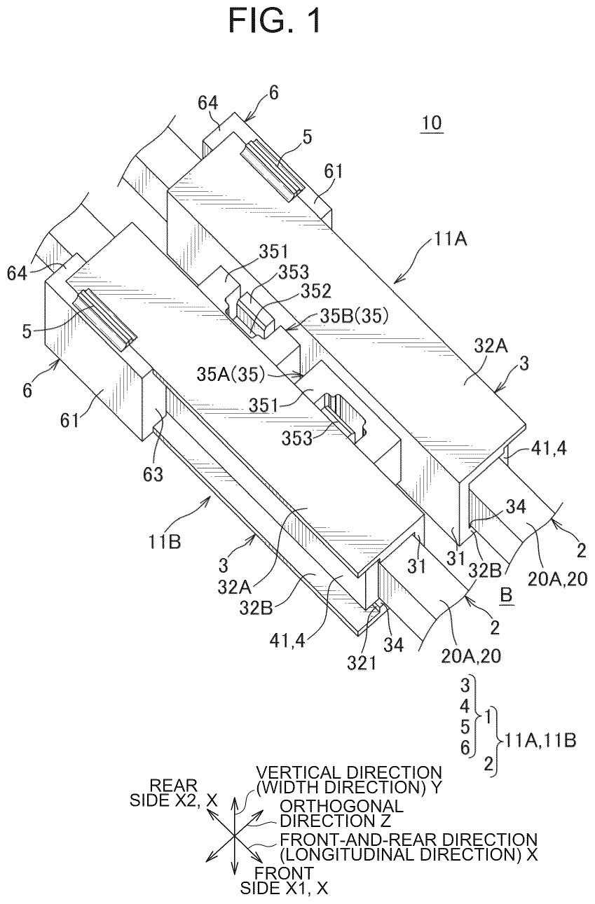

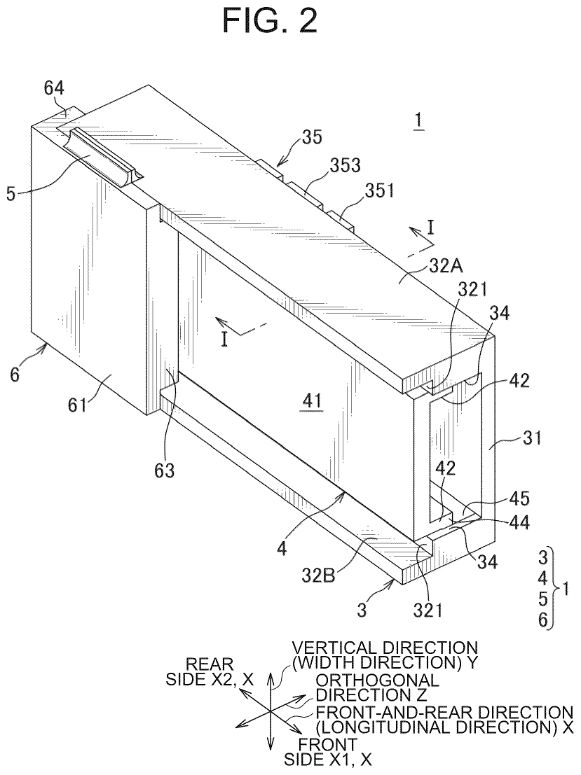

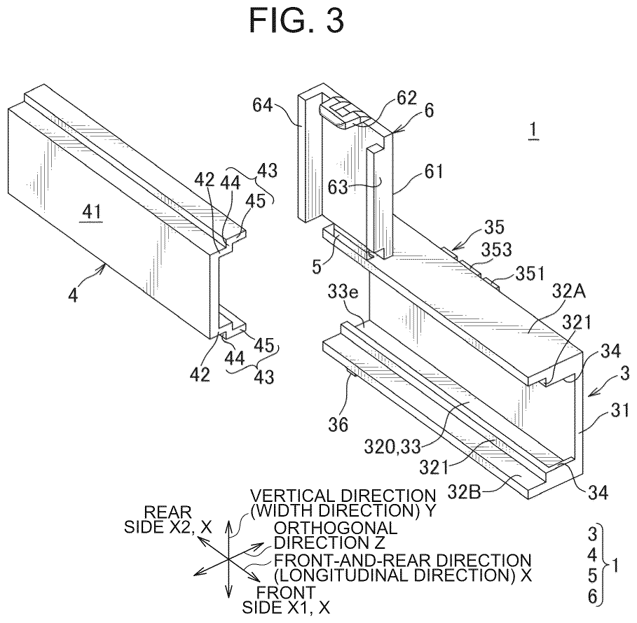

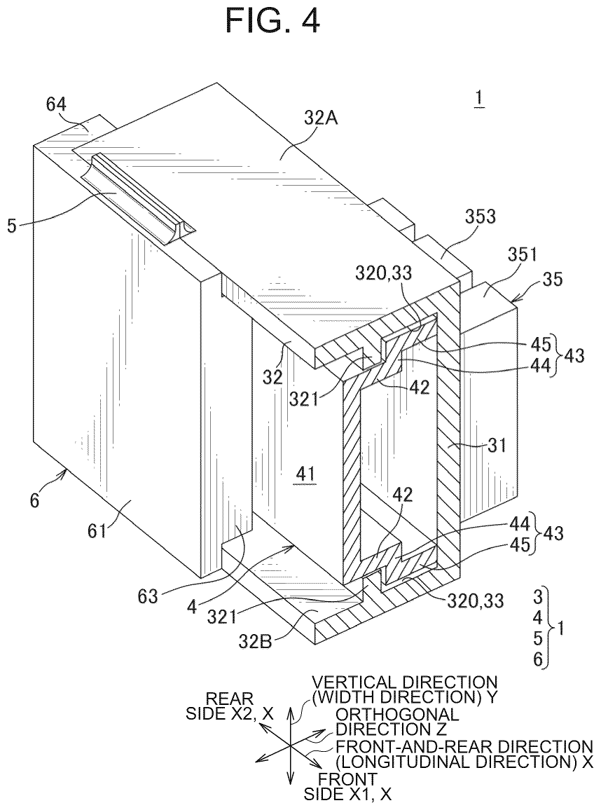

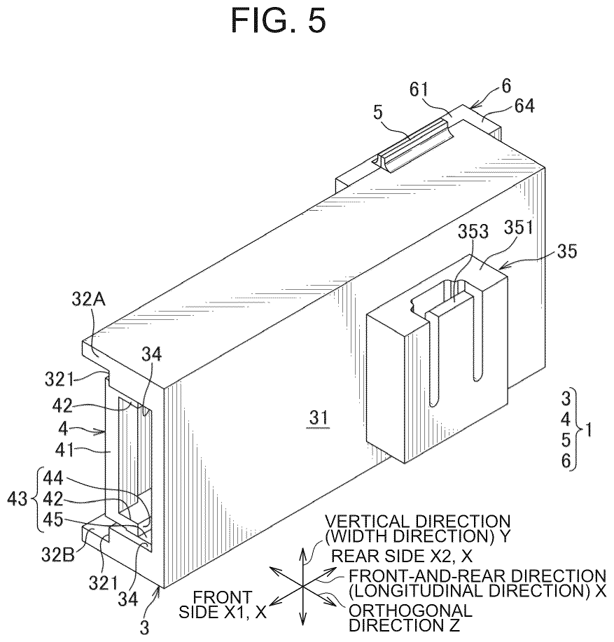

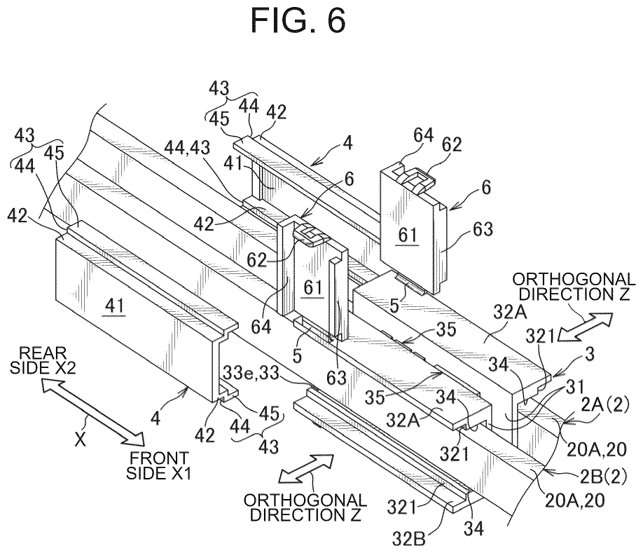

Hereinafter, an embodiment of the present invention is described with reference to the drawings. FIG. 1 is a perspective view illustrating a vehicle body fixing structure 10 according to an embodiment of the present invention that is fixed to a vehicle body B. FIG. 2 is a perspective view illustrating a holder body 1 that constitutes the vehicle body fixing structure 10. FIG. 3 is an exploded perspective view illustrating the disassembled holder body 1. FIG. 4 is a cross-sectional view taken along line I-I of FIG. 2. FIG. 5 is a perspective view of the holder body 1 from a different angle. FIG. 6 is a perspective view for explaining how the vehicle body fixing structure 10 is assembled.

As illustrated in FIG. 1, the vehicle body fixing structure 10 according to the present embodiment has a pair of bus bar support bodies 11A, 11B, which electrically connect connection targets such as battery cells mounted on a vehicle, and are fixed to respective fixing protrusions (fixing targets of the vehicle body B) (not illustrated) provided on the vehicle body B.

The pair of bus bar support bodies 11A, 11B illustrated in FIG. 1 each includes a bus bar 2 having a straight portion 20 in a strip shape, and a holder body 1 which supports the straight portion 20 and is fixed to the fixing protrusion vertically provided on the vehicle body B. The pair of bus bar support bodies 11A, 11B are fixed to the fixing protrusions provided on the vehicle body B such that the holder main bodies 3 explained later constituting the holder bodies 1 are arranged back-to-back.

As illustrated in FIG. 1, the bus bar 2 integrally includes a straight portion 20 and a pair of connection portions (not illustrated) that are provided on both sides of the straight portion 20 in the longitudinal direction X and are electrically connected to the connection targets. Each of the bus bars 2 is configured such that the outer surface of the straight portion 20 is covered with an insulating coating portion 20A having insulating properties. The longitudinal size of the straight portion 20 is formed to be longer than the longitudinal size of the holder main body 3 (explained below) provided on the holder body 1, and when the bus bar 2 is supported by the holder body 1, both ends of the straight portion 20 in the longitudinal direction X are arranged to protrude from the holder main body 3. That is, the holder main body 3 is provided only along part of the straight portion 20 in the longitudinal direction X, and is not provided over the entire length of the straight portion 20 in the longitudinal direction X.

In the following, the longitudinal direction of the straight portion 20 and the holder main body 3 (a receiving plate 31) may be referred to as a “longitudinal direction” or a “front-and-rear direction” and may be denoted by an “arrow X”, the width direction of the receiving plate 31, explained later, of the holder main body 3 may be referred to as a “width direction” or a “vertical direction” and may be denoted by an “arrow Y”, and a direction which is orthogonal to the arrow X and the arrow Y and in which the pair of bus bar support bodies 11A and 11B are arranged in the vehicle body fixing structure 10 may be referred to as an “orthogonal direction” and may be denoted by an “arrow Z”. In addition, in the front-and-rear direction X, the sliding direction of a sliding cover 4 (a cover material, described later) that constitutes the holder body 1 may be referred to as a “front side X1”, and the opposite direction may be referred to as a “rear side X2”.

As illustrated in FIGS. 2, 3, the holder body 1 includes a holder main body 3 in the shape of a gutter capable of accommodating a portion of the straight portion 20 of the bus bar 2 in the longitudinal direction X, a sliding cover 4 (cover material) in a plate shape provided on the holder main body 3 in a slidable manner, and a hinge cover 6 (pressing portion) connected to the holder main body 3 via a hinge 5 to press and support the sliding cover 4.

As illustrated in FIGS. 2, 3, the holder main body 3 includes the receiving plate 31 in a strip shape on which the straight portion 20 of the bus bar 2 is placed, a pair of opposing plates 32A, 32B vertically provided on the edges of the receiving plate 31 and opposing each other in the width direction Y, grooves 33 provided on the respective opposing plates 32A, 32B to allow the sliding cover 4 to slide in the longitudinal direction X, stop walls 34 provided at the end portions of the grooves 33 on the front side X1 to stop the sliding cover 4 from sliding, and a fixed portion 35 that is configured to be fixed to the fixing protrusion provided on the vehicle body B. Hereinafter, one of the pair of opposing plates 32A, 32B may be referred to as an “upper opposing plate 32A”, and the other of the opposing plates 32A, 32B may be referred to as a “lower opposing plate 32B”.

The longitudinal size of each of the opposing plates 32A, 32B is formed to be the same as the longitudinal size of the receiving plate 31. In addition, as illustrated in FIG. 3, a lock-receiving portion 36 in a protruding shape, which is configured to engage with a locking portion 62 (described later) provided on the hinge cover 6, is provided on the lower surface of the lower opposing plate 32B (the surface away from the upper opposing plate 32A).

As illustrated in FIGS. 3, 4, the groove 33 is a space surrounded by opposing surfaces 320 of the respective opposing plates 32A, 32B, rib portions 321 protruding from the respective opposing surfaces 320, and the receiving plate 31, and is configured in the shape of a groove in which the sliding cover 4 is slidable. The rib portions 321 are spaced apart from the receiving plate 31 in the orthogonal direction Z and extend in the front-and-rear direction X. As illustrated in FIG. 3, the stop walls 34 are provided at the end portions on the front side X1 of the grooves 33, and entry portions 33e for allowing the sliding cover 4 to enter the grooves 33 are provided at the end portions on the rear side X2 of the grooves 33.

As illustrated in FIGS. 3, 5, the stop walls 34 are provided at the end portions on the front side X1 of the sliding cover 4 in the grooves 33, and protrude from the respective opposing surfaces 320 so as to seal the gap between the receiving plate 31 and the rib portions 321. The sliding cover 4 is stopped from sliding by coming into contact with the stop walls 34.

As illustrated in FIGS. 1, 5, the fixed portion 35 protrudes from the outer surface of the receiving plate 31 opposite the pair of opposing plates 32A, 32B. In this case, as illustrated in FIG. 1, the fixed portion 35A (35) provided on the holder main body 3 of one of the pair of bus bar support bodies 11A, 11B and the fixed portion 35B (35) provided on the holder main body 3 of the other of the pair of bus bar support bodies 11A, 11B are provided at positions offset in the front-and-rear direction X such that they do not overlap each other when the bus bar support bodies 11A, 11B are fixed to the vehicle body B.

As illustrated in FIGS. 1, 5, the fixed portion 35 includes: a fixed portion main body 351 protruding from the outer surface of the receiving plate 31 and formed in a frame shape extending in the vertical direction Y, into which the fixing protrusion provided on the vehicle body B is inserted; and a locking arm 353 provided on the fixed portion main body 351 and having a protrusion 352 (illustrated in FIG. 1) for engaging with the inserted fixing protrusion.

As illustrated in FIGS. 3, 4, the sliding cover 4 includes: a sliding cover main body 41 in a strip shape; a pair of support plates 42, 42 provided protruding from an edge, in the width direction Y, of the sliding cover main body 41 toward the holder main body 3 and capable of supporting the bus bar 2 between each other; and a pair of sliding portions 43, 43 provided continuously to the pair of support plates 42, 42 and configured to engage with the respective rib portions 321 provided on the holder main body 3 such that the pair of sliding portions 43, 43 are slidable in the groove 33. The longitudinal size of the sliding cover main body 41, the longitudinal size of each of the support plates 42, and the longitudinal size of each of the sliding portions 43 are formed to be the same.

In addition, the longitudinal size of the sliding cover 4 is formed to be smaller than the longitudinal size of the holder main body 3 by the thickness of the stop wall 34, and when the end portion on the front side X1 of the sliding cover 4 comes into contact with the stop walls 34 provided on the holder main body 3, the end face on the rear side X2 of the sliding cover 4 and the end face on the rear side X2 of the holder main body 3 are configured to be located on the same plane.

The distance between the pair of support plates 42, 42 in the vertical direction Y is formed to be approximately the same as the width size of the straight portion 20 or slightly larger than the width size of the straight portion 20, and is configured to accommodate the straight portion 20 between the pair of support plates 42, 42.

As illustrated in FIGS. 3, 4, each of the pair of sliding portions 43, 43 includes: a pair of extending portions 44, 44 provided to extend outward in the vertical direction Y from the pair of support plates 42, 42 such that the extending portions 44, 44 can engage with the respective rib portions 321; and a pair of contact portions 45, 45 vertically provided on the pair of extending portions 44, 44 toward the holder main body 3 such that the contact portions 45, 45 face the opposing surfaces 320 of the respective grooves 33 provided on the holder main body 3 to be able to come into contact with the opposing surfaces 320.

As illustrated in FIG. 4, in the sliding cover 4, the pair of support plates 42, 42 are positioned between the pair of rib portions 321 provided on the holder main body 3, and the extending portions 44 engage with the respective rib portions 321, and the sliding cover 4 is slidable in the respective grooves 33 of the holder main body 3 such that the contact portions 45 face the opposing surfaces 320 of the respective grooves 33 provided on the holder main body 3.

As illustrated in FIG. 3, the hinge cover 6 is provided at the end portion on the rear side X2 of the holder main body 3. The hinge cover 6 includes a hinge cover main body 61 (pressing portion main body) in a rectangular plate shape that is continuous to the edge of the upper opposing plate 32A of the holder main body 3 via the hinge 5, a locking portion 62 provided on the edge of the hinge cover main body 61 on the side opposite to the hinge 5 and capable of engaging with the lock-receiving portion 36 of the holder main body 3, and a contact rib 63 and a fall prevention wall 64 provided on the hinge cover main body 61 and facing each other in the front-and-rear direction X.

As illustrated in FIG. 3, the locking portion 62 is provided on the edge of the hinge cover main body 61 to protrude in a C shape in the thickness direction of the hinge cover main body 61. Also, the locking portion 62 is configured to engage with the lock-receiving portion 36 provided on the holder main body 3 by positioning the lock-receiving portion 36 provided on the holder main body 3 inside the locking portion 62.

As illustrated in FIG. 3, the contact rib 63 is provided in a plate shape vertically provided from the edge on the front side X1 of the hinge cover main body 61 and is configured to come into contact with the sliding cover main body 41 when the locking portion 62 engages with the locked portion 36 of the holder body 3. This contact rib 63 is configured to be able to enter between the pair of opposing plates 32A, 32B of the holder main body 3.

As illustrated in FIG. 3, the fall prevention wall 64 is provided in a plate shape vertically provided from the edge on the rear side X2 of the hinge cover main body 61 so as to face the contact rib 63. This fall prevention wall 64 is configured to block each entry portion 33e of the pair of grooves 33 provided in the holder main body 3 to prevent the sliding cover 4 from falling off, when the locking portion 62 engages with the lock-receiving portion 36 of the holder main body 3.

Subsequently, assembly procedures for assembling the bus bar support body 11A (11B) including the holder body 1 and the vehicle body fixing structure 10 according to the present embodiment are described below with reference to FIGS. 1, 4, and 6.

First, as illustrated in FIG. 6, the bus bar 2 is brought close to the receiving plate 31 of the holder main body 3 so as to face the receiving plate 31, so that the bus bar 2 is placed between the pair of opposing plates 32A, 32B.

Thereafter, the front edge of the sliding cover 4 is brought close to the entry portion 33e of each of the grooves 33 of the holder main body 3. As a result, the pair of support plates 42, 42 are positioned between the pair of rib portions 321 provided on the holder main body 3, and the sliding portions 43 engage with the rib portions 321. Accordingly, the sliding cover 4 becomes slidable in the grooves 33 of the holder main body 3.

At this time, as illustrated in FIG. 4, the bus bar 2 is positioned between the pair of support plates 42, 42 of the sliding cover 4 in the vertical direction Y, and between the receiving plate 31 of the holder main body 3 and the sliding cover main body 41 of the sliding cover 4 in the orthogonal direction Z. In this state, the sliding cover 4 is caused to slide along the grooves 33 provided on the holder main body 3.

The sliding of the sliding cover 4 toward the front side X1 progresses, and the front edge of the sliding cover 4 comes into contact with the stop walls 34, causing the sliding of the sliding cover 4 to stop. As a result, the sliding cover 4 is positioned at a predetermined position of each groove 33. In this case, the end face on the rear side X2 of the sliding cover 4 and the end face on the rear side X2 of the holder main body 3 are located on the same plane.

Thereafter, the hinge cover 6 is rotated around the hinge 5 in a direction to approach the lock-receiving portion 36. As a result, as illustrated in FIG. 1, the locking portion 62 engages with the lock-receiving portion 36 of the holder main body 3. In this case, the contact rib 63 of the hinge cover 6 comes into contact with the sliding cover 4, and the sliding cover 4 is pressed down by the contact rib 63.

At substantially the same time, the fall prevention wall 64 is installed to face the end face on the rear side X2 of the sliding cover 4 and the end face on the rear side X2 of the holder main body 3, blocking the entry portions 33e of the pair of grooves 33 provided on the holder main body 3. This prevents the sliding cover 4 from falling off the holder main body 3, and also attaches the sliding cover 4 to the holder main body 3. Accordingly, the bus bar 2 is supported by the holder body 1. In this manner, assembly of the bus bar support body 11A is completed. This process is repeated to assemble the pair of bus bar support bodies 11A, 11B.

Next, the fixed portions 35 of the holder main bodies 3 of the bus bar support bodies 11A, 11B are brought close to the fixing protrusions provided on the vehicle body B, and the fixing protrusions are inserted into the fixed portions 35. As a result, the locking arms 353 provided on the fixed portions 35 are bent by being pushed by the fixing protrusions, and the protruding portions 352 engage with the fixing protrusions. In this way, the bus bar support bodies 11A, 11B are fixed to the fixing protrusions provided on the vehicle body B. In this case, as illustrated in FIG. 1, the bus bar support bodies 11A, 11B are fixed to the vehicle body B with the receiving plates 31 of the holder main bodies 3 facing each other (in a back-to-back manner). In this way, the assembly of the vehicle body fixing structure 10 is completed. After this, the connection targets such as battery cells are electrically connected to each other using the pair of bus bars 2, 2 supported by the pair of bus bar support bodies 11A, 11B.

Next, the procedure for removing only the pair of bus bars 2, 2 when the pair of bus bar support bodies 11A, 11B have been fixed to the vehicle body B (the vehicle body fixing structure 10) is described below with reference to FIG. 6.

First, the electrical connections to the connection targets such as the battery cells by the pair of bus bars 2, 2 are released. Then, the locking portion 62 of the hinge cover 6 is disengaged from the lock-receiving portion 36, and the hinge cover main body 61 is rotated around the hinge 5 in a direction away from the lock-receiving portion 36. This releases the contact rib 63 of the hinge cover 6 from pressing down on the sliding cover 4, and the fall prevention wall 64 of the hinge cover 6 moves away from the end face on the rear side X2 of the sliding cover 4 and the end face on the rear side X2 of the holder main body 3, thus making the sliding cover 4 slidable.

Thereafter, the sliding cover 4 is slid toward the rear side X2 along the groove 33. As the sliding progresses, the engagement of the sliding portions 43 of the sliding cover 4 with the rib portions 321 is released, and the sliding cover 4 is removed from the holder main body 3.

Thereafter, as illustrated in FIG. 6, one bus bar 2A of the pair of bus bars 2A, 2B (2) is moved in a direction away from the other bus bar 2B, thereby removing the one bus bar 2A from the holder main body 3. Then, the other bus bar 2B of the pair of bus bars 2A, 2B is moved in a direction away from the holder body 1 of one bus bar support body 11A, thereby removing the other bus bar 2B from the holder main body 3. In this way, with the vehicle body fixing structure 10, only the bus bars 2 are removed from the holder main bodies 3, while the pair of holder main bodies 3, 3 remain fixed to the vehicle body B.

According to the above-described embodiment, provided are: the holder main body 3 in the gutter shape capable of accommodating the straight portion 20 of the bus bar 2; the sliding cover 4 (cover material) in the plate shape assembled to the holder main body 3 such that the straight portion 20 is covered and held by the sliding cover 4 and the holder main body 3; and the hinge cover 6 (pressing portion) provided on a side away from the straight portion 20 with respect to the sliding cover 4 so as to press and support the sliding cover 4. The hinge cover 6 includes the hinge cover main body 61 (pressing portion main body) and the contact rib 63 provided to protrude from the hinge cover main body 61 toward the sliding cover 4 and capable of coming into contact with the sliding cover 4. Accordingly, with the holder body 1, the bus bar 2 can be removed from the holder main body 3 by separating the contact rib 63 of the hinge cover 6 from the sliding cover 4 and disassembling the sliding cover 4 and the holder main body 3. This makes it possible to remove only the bus bars 2 to perform maintenance and other work while the holder main bodies 3 remain fixed to the fixing protrusions (the fixing targets) of the vehicle body B, so that the ease of work can be improved.

In addition, one end of the hinge cover main body 61 (pressing portion main body) is connected to the holder main body 3 via the hinge 5, and the other end of the hinge cover main body 61 that is away from the one end of the hinge cover main body 61, with respect to the contact rib 63 being interposed between the one end and the other end, is provided with the locking portion 62 capable of engaging with the holder main body 3. Accordingly, when the locking portion 62 engages the lock-receiving portion 36 provided on the holder main body 3 by rotating the hinge cover 6 around the hinge 5, the contact rib 63 of the hinge cover 6 comes into contact with the sliding cover 4, and the sliding cover 4 is pressed down by the hinge cover 6, so that the sliding cover 4 is assembled to the holder main body 3. In other words, the sliding cover 4 can be assembled to the holder main body 3 by rotating the hinge 5, so that the ease of assembly can be improved.

The holder main body 3 includes the grooves 33 configured to slide the sliding cover 4 (cover material), and the stop walls 34 configured to come into contact with the sliding cover 4 to stop the sliding of the sliding cover 4. By bringing the sliding cover 4 to come into contact with the stop walls 34, the sliding cover 4 can be stopped at a predetermined position without falling off, and the sliding cover 4 can be positioned at the predetermined position.

Furthermore, the hinge cover 6 (pressing portion) includes the fall prevention wall 64 that protrudes from the hinge cover main body 61 (pressing portion main body) so as to face the contact rib 63 and that blocks the entry portions 33e of the pair of grooves 33 provided in the holder main body 3, thereby preventing the sliding cover 4 (cover material) from falling off to the rear side X2 (the side opposite to the sliding direction). Accordingly, due to the fall prevention wall 64, the sliding cover 4 can be prevented from falling off the holder main body 3.

With the holder body 1 according to the present embodiment, by rotating the hinge cover 6 around the hinge 5, the locking portion 62 engages the lock-receiving portion 36 provided on the holder main body 3, and the contact rib 63 abuts against the sliding cover 4, and the fall prevention wall 64 blocks the entry portions 33e of the pair of grooves 33. As a result, the sliding cover 4 is more firmly attached to the holder main body 3 by the hinge cover 6. This makes it possible to improve the ease of assembly of the holder body 1 and the ease of removal of the bus bar 2 from the holder body 1.

The pair of bus bar support bodies 11A, 11B are arranged such that the fixed portions 35 are fixed to the fixing protrusions (the fixing targets of the vehicle body B) while the holder main bodies 3 are arranged back-to-back. In this case, when the bus bar 2 is removed from the holder body 1, the bus bar 2 is moved in the orthogonal direction Z away from the receiving plate 31 of the holder main body 3. In other words, when the bus bars 2 are removed from the holder bodies 1, the pair of bus bars 2A, 2B (2) are moved in opposite directions to each other. As a result, when the bus bars 2 are removed from the holder bodies 1, the bus bars 2 are restricted from coming closer to each other than a certain distance, and a countermeasure against short circuits can be established.

In addition, the holder main body 3 includes the fixed portion 35, such that the fixed portion 35 is provided on a surface of the receiving plate 31 opposite to the pair of opposing plates 32A, 32B, and the fixed portions 35A, 35B (35) provided on the bus bar support bodies 11A, 11B, respectively, are shifted in position in the longitudinal direction X of the holder main body 3. Accordingly, the pair of bus bar support bodies 11A, 11B can be fixed to the vehicle body B such that the pair of bus bar support bodies 11A, 11B are close to each other in the orthogonal direction Z. This makes it possible to reduce, in the orthogonal direction Z, the size of the vehicle body fixing structure 10, which includes the pair of bus bar support bodies 11A, 11B.

In addition, the size of the straight portion 20 in the longitudinal direction X (longitudinal size) is formed to be longer than the size of the holder main body 3 in the longitudinal direction X (longitudinal size). This makes it possible to freely set the fixing position of the holder main body 3 within the range of the straight portion 20, and even if the shape of the bus bar is changed due to the vehicle layout, the same holder body 1 can be used universally, thereby improving versatility.

The present invention is not limited to the above-described embodiment, and includes other configurations that can achieve the object of the present invention, and the following modifications are also included in the present invention.

In the above-described embodiment, the hinge cover 6 (pressing portion) is connected to the holder main body 3 via the hinge 5, but the present invention is not limited thereto. The pressing portion may be configured separately from the holder main body and may not be connected to the holder main body 3 via the hinge 5. The pressing portion only needs to be configured so as to be able to engage with the holder main body, and may have a structure capable of engaging with the holder main body instead of the hinge.

Although the holder body 1 according to the above-described embodiment is configured to have one hinge cover 6 (pressing portion) for the holder main body 3, the present invention is not limited thereto. The holder body may have a pair of pressing portions, which may be provided at both end portions of the holder main body 3, and the fall prevention walls 64 may be provided to cover the end portions of the grooves 33 in the front-and-rear direction X. In this case, the holder main body may not be provided with the stop walls.

Although the best configuration, method, and the like for carrying out the present invention are disclosed in the above description, the present invention is not limited thereto. That is, although the present invention has been particularly illustrated and described primarily with respect to the particular embodiment, it is understood that, without departing from the spirit and scope of the present invention, the present invention can be modified in various ways by those skilled in the art in terms of shape, material, quantity, and other detailed configurations of the embodiment described above. Therefore, since the descriptions that limit the shape, material, and the like disclosed above are illustrative examples to facilitate understanding of the present invention, and do not limit the present invention, a description with a name of a member, from which some or all of the limitations on the shape, material, and the like are deleted, is to be included in the present invention.

### LIST OF REFERENCE SIGNS

10 vehicle body fixing structure
11A, 11B pair of bus bar support bodies
1 holder body
2 bus bar
20 straight portion
20A insulating coating portion
3 holder main body
31 receiving plate
32A,32B pair of opposing plates
33 groove
34 stop wall
35 fixed portion
4 sliding cover (cover material)
5 hinge
6 hinge cover (pressing portion)
61 hinge cover main body (pressing portion main body)
62 locking portion
63 contact rib
64 fall prevention wall
B vehicle body

What is claimed is:

1. A holder body configured to support a bus bar having a straight portion in a strip shape, and to be fixed to a fixing target of a vehicle body, comprising:
a holder main body in a shape of a gutter capable of accommodating the straight portion;
a cover material in a plate shape assembled onto the holder main body and configured to cover and hold the straight portion with the holder main body; and
a pressing portion provided on a side away from the straight portion with respect to the cover material so as to press and support the cover material,
wherein the pressing portion includes:
a pressing portion main body in a plate shape provided to be able to engage with the holder main body so as to face the cover material; and
a contact rib provided to protrude in a plate shape from the pressing portion main body toward the cover material so as to be able to come into contact with the cover material.

2. The holder body according to claim 1, wherein one end of the pressing portion main body is connected to the holder main body via a hinge, and
the other end of the pressing portion main body that is away from the one end of the pressing portion main body, with the contact rib being interposed between the one end and the other end, is provided with a locking portion capable of engaging with the holder main body.

3. The holder body according to claim 2, wherein the holder main body includes:
a groove configured to slide the cover material in a longitudinal direction of the holder main body;
a stop wall located at an end portion of the groove in a sliding direction of the cover material and configured to come into contact with the cover material to stop sliding of the cover material.

4. The holder body according to claim 3, wherein the pressing portion includes a fall prevention wall that protrudes from the pressing portion main body so as to face the contact rib and configured to prevent the cover material from falling off to a side opposite to the sliding direction of the cover material.

5. A vehicle body fixing structure comprising:
a pair of bus bar support bodies each including the holder body according to claim 1 and the bus bar,
wherein the bus bar is configured such that an outer surface of the straight portion is covered with an insulating coating portion having an insulating property,
the holder body of each of the pair of bus bar support bodies includes a fixed portion configured to be fixed to the fixing target, and
the pair of bus bar support bodies are fixed such that each of the fixed portion is fixed to the corresponding fixing target while the holder main bodies are arranged back-to-back.

6. The vehicle body fixing structure according to claim 5, wherein the holder main body includes:
a receiving plate on which the straight portion is placed; and
a pair of opposing plates vertically provided from edges of the receiving plate in a width direction,
wherein the fixed portion of each of the bus bar support bodies is provided on a surface of the receiving plate opposite to the pair of opposing plates, and
the fixed portions provided on the respective holder main bodies are shifted in position in a longitudinal direction of the holder main body.

7. The vehicle body fixing structure according to claim 5, wherein a longitudinal size of the straight portion is greater than a longitudinal size of the holder main body.

8. The vehicle body fixing structure according to claim 6, wherein a longitudinal size of the straight portion is greater than a longitudinal size of the holder main body.
